(19) United States
(12) Patent Application Publication
(10) Pub. No.: US 2010/0008098 A1
(43) Pub. Date: Jan. 14, 2010

(54) APPARATUS AND METHOD TO DETER PACK RAT NESTING IN VEHICLES

(76) Inventor: DAVID P. VERNON, TUCSON, AZ (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 12/172,192

(22) Filed: Jul. 11, 2008

(51) Int. Cl. B60Q 1/00; H01M 10/44

(52) U.S. Cl. 362/487; 320/127

(57) ABSTRACT

A method to deter pack rat nesting in a vehicle engine compartment, comprising illuminating said engine compartment between sunset and sun rise.

### FIELD OF THE INVENTION

The invention is directed to an apparatus and method to deter pack rat nesting in the engine compartment of a vehicle.

### BACKGROUND OF THE INVENTION

Pack rats are found in the Southwestern United States. They are collectors by nature and, when they see something they like they take it. In the same manner, if they see a parked car with a still warn engine on a cold winter's night, they are not adverse to crawling up under the hood and warming themselves. An additional attraction of a car's engine compartment is that while it is easily accessible to a pack rat it is not easily accessible to predators such as bobcats, coyotes, owls and snakes. If the car is returned to the same spot every night, packrats often build a nest under the hood.

Pack Rats nesting under the hoods of cars is a problem in the Southwest, because they not only cause expensive damage to cars, but once they establish themselves in a car it is very difficult to get rid of them. When pack rat families build nests and move in under the hood of a car, the odor from their feces and urine lingers even after the nests are discovered, destroyed and the rats chased out. While not very noticeable to humans, this odor is easily detectable by other pack rats thereby advertising that car as a good place in which to nest.

### SUMMARY OF THE INVENTION

Applicant's invention comprises a method to deter pack rat nesting in a vehicle engine compartment. The method provides a plurality of light emitting devices, disposes that plurality of light emitting devices within the engine compartment, energizes the plurality of light emitting devices after sunset, emits light by each of said plurality of light emitting devices while that light emitting device is energized, and discontinues energizing the plurality of light emitting devices after sun rise.

### BRIEF DESCRIPTION OF THE DRAWINGS

The invention will be better understood from a reading of the following detailed description taken in conjunction with the drawings in which like reference designators are used to designate like elements, and in which:

FIG. 1 is a prospective view of a portion of a vehicle showing an engine compartment, an engine disposed in that engine compartment, and a hood element;

FIG. 2A is a block diagram showing one embodiment of Applicant's apparatus;

FIG. 2B is a block diagram showing an embodiment of Applicant's light emitting device;

FIG. 3 is a block diagram showing a second embodiment of Applicant's apparatus; and

FIG. 4 graphically displays a solar spectrum as received at the top of earth's atmosphere and a solar spectrum as received at sea level.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Pack Rats nesting under the hoods of vehicles is a problem in the Southwest. A vehicle's engine compartment is easily accessible to a pack rat it, but is not easily accessible to predators such as bobcats, coyotes, owls and snakes. Pack rats tend to roam at night under the cover of darkness. Through centuries of adaptation, pack rats have evolved to be less mobile on moonlit nights. The light of the moon makes a pack rat more visible to predators. Many pack rat predators are also active at night. Examples include owls, bobcats, and snakes.

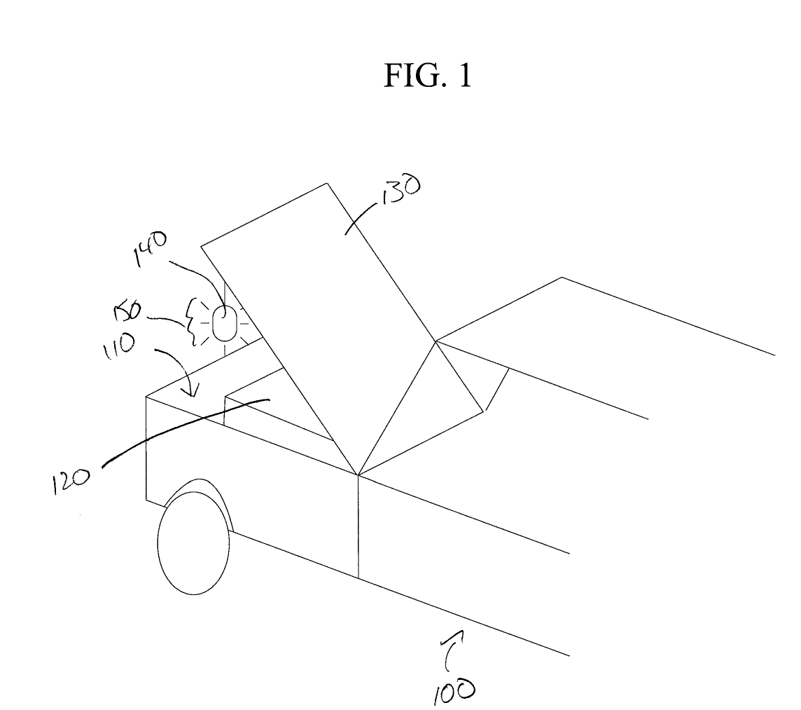

Applicant has further discovered that illuminating an engine compartment during the nighttime hours dissuades pack rats from entering into that engine compartment, and nesting in that engine compartment. The illustrated embodiment of FIG. 1 shows vehicle 100 comprising an engine compartment 110, an engine 120 disposed in that engine compartment, and a hood 130 shown in the raised position. Light emitting device 140 is shown attached to raised hood 130 such that emitted light illuminates engine compartment 110.

The illustrated embodiment of FIG. 1 is not a preferred embodiment of Applicant's apparatus and method. Applicant has found that the emitted light 150 does not sufficiently illuminate engine compartment 110. As those skilled in the art will appreciate, a modern vehicle engine comprises a plurality of parts, assemblies, and attached devices, such as and without limitation one or more batteries, window-washing fluid containers, coolant overflow containers, air conditioning units, smog control devices, and the like. Each of these assemblies/devices can effectively block the light energy 150, and create shadowed areas within engine compartment 110. Applicant has discovered that any confined space within an engine compartment 110 comprising a volume of about 125 cubic inches (an area roughly 5″×5″×5″), or greater, that remains shadowed or dark, remains a viable hiding/nesting place for pack rats. By “confined space,” Applicant means any contiguous space having an opening therein greater than or equal to about 30 square inches.

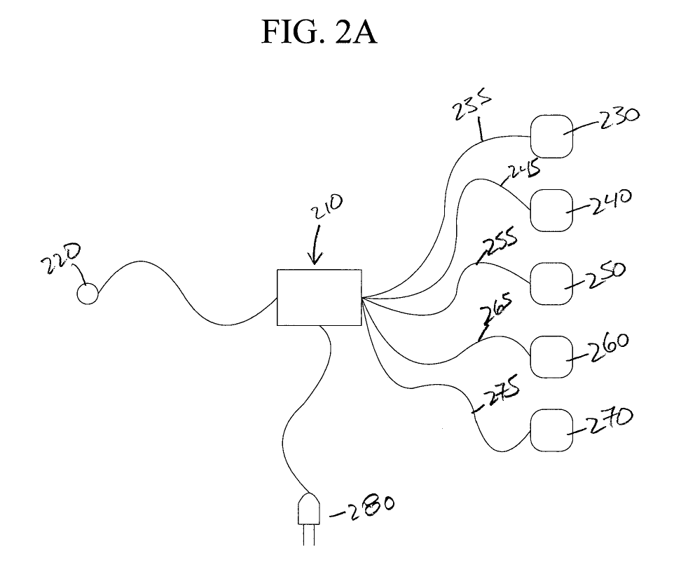

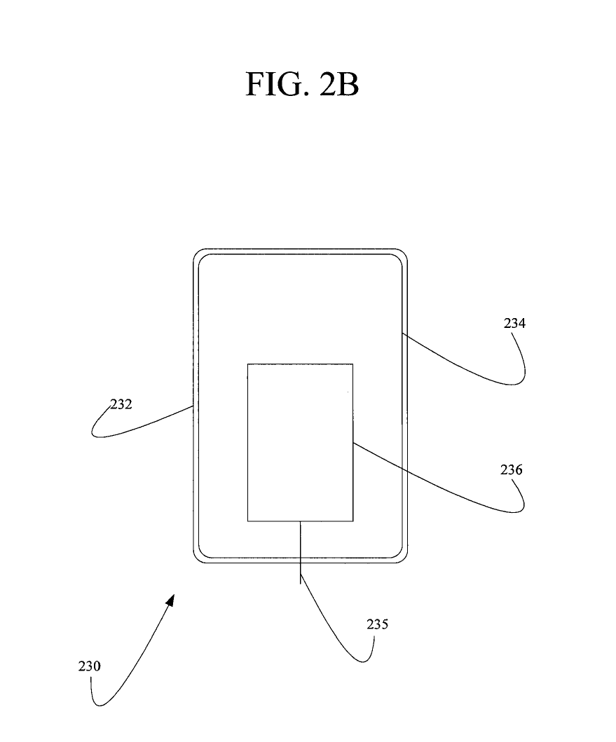

Referring now to FIG. 2A, Applicant's apparatus 200 comprises a controller 210, a photocell 220, a plurality of light emitting devices 230, 240, 250, 260, and 270, and a power source 280. In certain embodiments, light emitting device 230, 240, 250, 260, and 270, comprise light emitting diodes. In certain embodiments, light emitting device 230, 240, 250, 260, and 270, comprise incandescent light bulbs.

As those skilled in the art will appreciate, moon light is reflected sun light. Numerous studies have demonstrated that the spectrum of electromagnetic radiation emitted by the sun is identical to the spectrum of moon light.

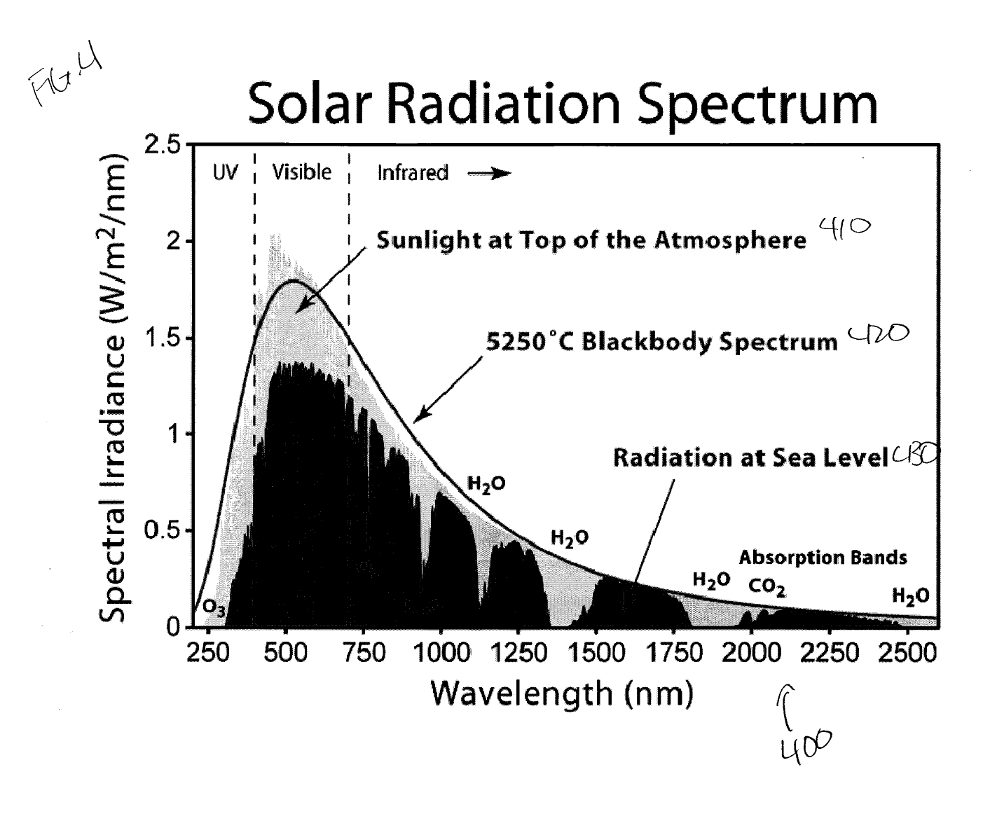

Referring now to FIG. 4, graph 400 shows a variety of spectra, including spectra 410, 420, and 430. Spectrum 410 comprises a plot of wavelength versus power for the electromagnetic radiation received from the sum at the top of Earth's atmosphere. Spectrum 420 comprises a plot of wavelength versus power for the electromagnetic radiation emitted by an object heated to 5250 degrees Celsius. Spectrum 430 comprises a plot of wavelength versus power for the electromagnetic radiation received from the sum at the Earth's surface. Spectra 410 and 430 show that the solar spectrum is continuous with dark lines, i.e. the famous Fraunhofer lines, such as: C line in dark red(H-alpha, 656 nm), orange D(Na, 589 nm), green E(Fe, 527 nm) and b1,b2(Mg, 518 nm), blue F(H-beta, 486 nm), purple G(Fe and Ca, 431 nm).

The dark lines in the solar spectrum are caused by absorption by certain elements in the upper layers of the sun, and/or absorption by water and/or oxygen molecules in the Earth's atmosphere. TABLE 1 recites the origin of, and wavelength of, various of the Fraunhofer lines.

TABLE 1

| Designation | Element | Wavelength (nm) |
|---|---|---|
| y | O₂ | 898.765 |
| Z | O₂ | 822.696 |
| A | O₂ | 759.370 |
| B | O₂ | 686.719 |
| C | Hα | 656.281 |
| a | O₂ | 627.661 |
| D₁ | Na | 589.592 |
| D₂ | Na | 588.995 |
| D₃ or d | He | 587.5618 |
| e | Hg | 546.073 |
| E₂ | Fe | 527.039 |
| b₁ | Mg | 518.362 |
| b₂ | Mg | 517.270 |
| b₃ | Fe | 516.891 |
| b₄ | Fe | 516.891 |
| b₄ | Mg | 516.733 |
| c | Fe | 495.761 |
| F | Hβ | 486.134 |
| d | Fe | 466.814 |
| e | Fe | 438.355 |
| G′ | Hγ | 434.047 |
| G | Fe | 430.790 |
| G | Ca | 430.774 |
| h | Hδ | 410.175 |
| H | Ca⁺ | 396.847 |
| K | Ca⁺ | 393.368 |
| L | Fe | 382.044 |
| N | Fe | 358.121 |
| P | Ti⁺ | 336.112 |
| T | Fe | 302.108 |
| t | Ni | 299.444 |

Referring now to FIG. 2B, in certain embodiments Applicant's light emitting device 230 comprises an optically transparent housing 232, coating 234 disposed on the inner surface of that housing, and LED 236. Coating 234 absorbs certain frequencies from the light produced by LED 236 such that the light emitted from device 230 closely mimics the spectrum of solar light, and therefore, mimics the spectrum of moon light. Applicant has found that use of such “moon light mimicking” irradiation most effectively invokes a pack rat's adaptation to avoid movement in moon light.

In certain embodiments, Applicant's plurality of light emitting devices when energized emit electromagnetic energy comprising substantially all frequencies between about 250 nanometers and about 1500 nanometers. By “substantially all frequencies between about 250 nanometers and about 1500 nanometers, Applicant means a spectrum that mimics a portion of the solar spectrum of FIG. 4, i.e. a spectrum that includes a plurality of Fraunhofer Lines.

Using Applicant's method, light emitting devices 230, 240, 250, 260, and 270, are disposed within engine compartment 110. In certain embodiments, light emitting devices are placed within engine compartment such that no areas within engine compartment 110 comprising a volume of about 125 cubic inches, or larger, are not illuminated by one or more of the light emitting devices 230, 240, 250, 260, and/or 270. Using apparatus 200, when photocell 220 provides a signal to controller 210 that darkness has fallen, controller 210 energizes light emitting devices 230, 240, 250, 260, and 270. In certain embodiments, light emitting devices 230, 240, 250, 260, and 270, emit the “moon light mimicking” irradiation described hereinabove.

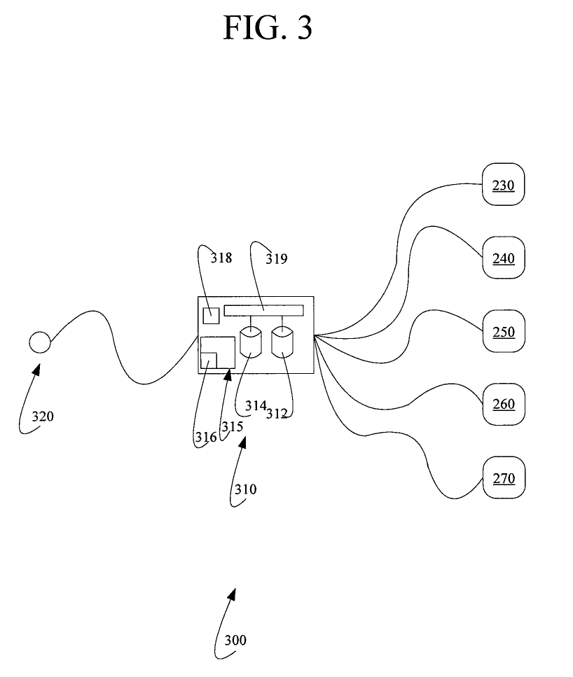

Referring now to FIG. 3, Applicant's apparatus 300 comprises a controller 310, wherein that controller 310 comprises a recharging circuitry 319 and a plurality of rechargeable batteries, such as batteries 312 and 314. The illustrated embodiment of FIG. 3 shows two batteries disposed in controller 310. In other embodiments, controller 310 comprises a single rechargeable battery. In still other embodiments, controller 310 comprises more than two rechargeable batteries.

Controller 310 further comprises processor 318 and computer readable medium 315. Instructions 316 are encoded in computer readable medium 315. Processor 318 utilizes instructions 316 to perform Applicant's method described herein. Apparatus 300 further comprises a photovoltaic assembly 320, and a plurality of light emitting devices 230, 240, 250, 260, and 270. In other embodiments, apparatus 300 comprises fewer than five light emitting devices. In still other embodiments, apparatus 300 comprises more that five light emitting devices. In certain embodiments, one or more of the light emitting devices shown in FIG. 3 comprises the elements shown in FIG. 2B.

As those skilled in the art will appreciate, photovoltaics comprise an apparatus and method using that apparatus to generate electricity using solar cells packaged in photovoltaic modules, often electrically connected in multiples as solar photovoltaic arrays to convert energy from the sun into electricity.

By “photovoltaic,” Applicant means the unbiased operating mode of a photodiode in which current through the device is entirely due to the transduced light energy. Solar cells produce direct current electricity from light, which can be used to power equipment or to recharge a battery.

In certain embodiments, photovoltaic assembly 320 requires protection from the environment, and is packaged behind a glass sheet. In certain embodiments, assembly 320 comprises a plurality of cells that are electrically connected together to form photovoltaic modules, or solar panels. In certain embodiments, photovoltaic assembly 320 comprises one or more photodiodes comprising thin film CdTe, CIGS, amorphous Si, microcrystalline Si, and the like.

In certain embodiments, photovoltaic assembly 320 is placed in sunlight, produces electrical energy, and provides that electrical energy to controller 310. Recharging circuitry 319 utilizes the electrical energy provided by photovoltaic assembly 320 to recharge batteries 312 and 314. In certain embodiments, controller 310 comprises a pre-determined DC voltage threshold encoded in instructions 316. When photovoltaic assembly 320 provides DC power comprising a voltage less than that threshold DC voltage, controller 310 energizes light emitting devices 230, 240, 250, 260, and 270.

Using Applicant's method, light emitting devices 230, 240, 250, 260, and 270, are disposed within engine compartment 110. In certain embodiments, light emitting devices are placed within engine compartment such that no areas within engine compartment 110 comprising a volume of about 125 cubic inches, or larger, are not illuminated by one or more of the light emitting devices 230, 240, 250, 260, and/or 270. Using apparatus 300, any time the ambient light is sufficiently dark such that the photovoltaic assembly 320 fails to generate electric power having a voltage greater than the threshold DC voltage, controller 310 energizes light emitting devices 230, 240, 250, 260, and 270. In certain embodiments, light emitting devices 230, 240, 250, 260, and 270, emit the “moon light mimicking” irradiation described hereinabove.

In certain embodiments, Applicant's invention includes instructions, such as instructions 124 (FIG. 1), residing in computer readable medium, such as for example memory 121 (FIG. 1 wherein those instructions are executed by a processor, such as processor 128 (FIG. 1), to perform Applicant's method described herein.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to deter pack rat nesting in a vehicle engine compartment, comprising illuminating said engine compartment between sunset and sun rise.

2. The method of claim 1, wherein said illuminating step further comprises:
providing a plurality of light emitting devices;
disposing said plurality of light emitting devices within said engine compartment;
energizing said plurality of light emitting devices after sunset;
emitting light by each of said plurality of light emitting devices while that light emitting device is energized;
discontinuing energizing said plurality of light emitting devices after sun rise.

3. The method of claim 2, further comprising:
providing a photoelectric cell;
interconnecting said photoelectric cell with said plurality of light emitting devices, such that said plurality of light emitting devices only emit light between sunset and sun rise.

4. The method of claim 3, wherein said illuminating step further comprises placing said plurality of light emitting devices within said engine compartment such that any confined space disposed in said engine compartment comprising a volume equal to or greater than 125 cubic inches and an opening therein less than about 30 square inches is illuminated by one or more of the plurality of light emitting devices.

5. The method of claim 4, wherein said vehicle comprises a hood partially covering said engine compartment, further comprising leaving said hood in an open configuration while said plurality of light emitting devices remain energized.

6. The method of claim 5, wherein said plurality of light emitting devices emit electromagnetic energy comprising substantially all frequencies between about 250 nanometers and about 1500 nanometers and which includes a plurality of Fraunhofer Lines.

7. The method of claim 2, further comprising:
providing a controller comprising a processor, one or more rechargeable batteries, recharging circuitry interconnect to each of said plurality of rechargeable batteries, a computer readable medium in communication with said processor, a DC threshold voltage level encoded in said computer readable medium, wherein said controller is interconnected to each of said plurality of light emitting devices;
a photovoltaic assembly comprising one or more photodiodes to convert solar energy into electrical energy, wherein said photovoltaic assembly is interconnected with said controller;
receiving sun light by said photovoltaic assembly;
providing electrical energy having an actual DC voltage by said photovoltaic assembly to said controller;
recharging said one or more rechargeable batteries;
determining if said actual DC voltage is less than said DC threshold voltage level;
operative if said actual DC voltage is less than said DC threshold voltage, energizing said one or more light emitting devices;
emitting light by each of said light emitting devices.

8. The method of claim 7, further comprising placing said plurality of light emitting devices within said engine compartment such that any confined space disposed in said engine compartment comprising a volume equal to or greater than 125 cubic inches and an opening therein less than about 30 square inches is illuminated by one or more of the plurality of light emitting devices.

9. The method of claim 8, wherein said plurality of light emitting devices emit electromagnetic energy comprising substantially all frequencies between about 250 nanometers and about 1500 nanometers and which includes a plurality of Fraunhofer Lines.

10. An article of manufacture comprising a processor, one or more rechargeable batteries, recharging circuitry interconnected to said one or more rechargeable batteries, and a computer readable medium comprising a DC threshold value encoded therein and computer readable code disposed therein, wherein said article of manufacture is interconnected to a photovoltaic assembly and to a plurality of light emitting devices, the computer readable program code comprising a series of computer readable program steps to effect:
receiving electrical energy having an actual DC voltage from said photovoltaic assembly;
recharging said one or more rechargeable batteries;
determining if said actual DC voltage is less than said DC threshold voltage level;
operative if said actual DC voltage is less than said DC threshold voltage, energizing said one or more light emitting devices.
operative if said actual DC voltage is not less than said DC threshold voltage, not energizing said one or more light emitting devices
